(19) United States
(12) Patent Application Publication
(10) Pub. No.: US 2026/0219645 A1
(43) Pub. Date: Jul. 30, 2026

(54) MACHINE TOOL AND THERMAL DISPLACEMENT CORRECTION METHOD FOR MACHINE TOOL

(71) Applicant: Sodick Co., Ltd., Kanagawa (JP)

(72) Inventors: Nishiki MIYAHARA, Kanagawa (JP); Asuma NARISHIMA, Kanagawa (JP); Yoshinobu YAMAMOTO, Kanagawa (JP)

(73) Assignee: Sodick Co., Ltd., Kanagawa (JP)

(21) Appl. No.: 19/430,305

(22) Filed: Dec. 23, 2025

(30) Foreign Application Priority Data
Jan. 27, 2025 (JP) 2025-011396

(51) Int. Cl. G05B 19/404; B23Q 15/007

(52) U.S. Cl. CPC G05B 19/404; B23Q 15/007

(57) ABSTRACT

First temperature sensors MS are respectively provided on surfaces of a Y-axis moving body, an X-axis moving body, and a U-axis moving body that are machine body components. A second temperature sensor AS is provided on a frame 10F located between a cover 10 and the machine body components. A first estimated temperature is calculated by correcting a detection temperature of the temperature sensor MS with a predetermined first correction coefficient, a second estimated temperature is calculated by correcting a detection temperature of the temperature sensor AS with a predetermined second correction coefficient. The second estimated temperature is added to obtain a synthesis temperature of each machine body component. A thermal displacement amount in a predetermined direction of the machine body is calculated based on the synthesis temperature, and thermal displacement correction in the predetermined direction is performed.

### CROSS-REFERENCE TO RELATED APPLICATION

This application claims the priority benefit of Japan application serial no. 2025-011396, filed on Jan. 27, 2025. The entirety of the above-mentioned patent application is hereby incorporated by reference herein and made a part of this specification.

### BACKGROUND

### Technical Field

The invention relates to a machine tool that performs thermal displacement correction and a thermal displacement correction method for a machine tool.

### Description of Related Art

Generally, in a machine tool, the machine body undergoes thermal displacement due to an ambient temperature change around the machine body, causing an error between the controlled machining position and the actual machining position. Therefore, the controlled machining position is corrected in correspondence with the thermal displacement amount of the machine body. The machine body is, as a whole, formed by combining multiple machine body components. Therefore, the thermal displacement amount generated in the entire machine body is simply the sum of the thermal displacement amounts of the respective multiple machine body components in a predetermined direction. The thermal displacement amount of a machine body component can be calculated and obtained from the internal temperature of the machine body component, the expansion coefficient of the machine body component, and the length of the machine body component in the direction of thermal displacement.

When the machine body expands or contracts due to an ambient temperature change in the environment, there is a time delay from the time when the machine body temperature changes following the ambient temperature change until the machine body temperature becomes the same as the ambient temperature and the expansion or contraction of the machine body is completed. The time required for thermal displacement of each of the machine body components forming the machine body differs considerably depending on the material and the volume of the machine body component. In other words, the time constant of the change in thermal displacement amount with respect to temperature change differs for each machine body component. Therefore, in the case of calculating the thermal displacement amount based on one representative machine body temperature for the overall thermal displacement amount of the machine body, an unacceptable error may occur between the calculated thermal displacement amount and the actual thermal displacement amount.

For example, Patent Document 1 discloses a method for performing thermal displacement correction by obtaining the thermal displacement amount in the spindle axis direction considering the time difference of thermal displacement time in each of the machine body components including a tool. Additionally, Patent Document 2 discloses a method for detecting temperature changes at at least two locations of a machine body having temperature changes with different time constants, calculating a synthesis temperature, and calculating the thermal displacement amount of the machine body based on the synthesis temperature.

### PRIOR ART DOCUMENT(S)

### Patent Document(s)

[Patent Document 1] Japanese Patent Publication No. H06-22779
[Patent Document 2] Japanese Patent Application Laid-Open Publication No. 2004-42260

To accurately calculate the thermal displacement amount, it is necessary to know the internal temperature of the machine body component. However, installing a temperature sensor at the center position inside the machine body component is physically difficult for many machine body components. Even if a temperature sensor is managed to be provided at an ideal position inside the machine body component, it will require efforts and cost, including machine body maintenance, that are not commensurate with the practical benefits. Therefore, for most components, the temperature sensor is provided on the surface of the machine body component at a position separated from the center position inside the machine body component.

Since a time difference occurs between the temperature changes of the inside and the surface of the machine body component, the temperature detected by the temperature sensor provided on the surface of the machine body component at a certain detection time differs from the temperature at an ideal position inside the machine body component. Additionally, since the temperature detected by the temperature sensor provided on the surface of the machine body component is affected by the ambient temperature in the environment, the detected temperature does not accurately indicate the temperature of the surface of the machine body component. Therefore, depending on the required machining accuracy, an unacceptable error may still occur between the calculated thermal displacement amount and the actual thermal displacement amount.

The invention provides an improved machine tool and thermal displacement correction method for the machine tool that can perform thermal displacement correction, taking into consideration the internal temperature of the machine body component.

### SUMMARY

A machine tool according to an embodiment of the invention includes: a first temperature sensor, provided on a surface of each of one or more machine body components selected for forming a machine body; and at least one second temperature sensor, provided in a non-contact manner with respect to each of the machine body components at a position opposing positions of all of the first temperature sensors, and detecting an ambient temperature around the machine body component; and a control device, including a first computing device and a second computing device and performing thermal displacement correction of the machine body in a predetermined direction. The first computing device is configured to calculate, for each of the one or more machine body components, a first estimated temperature by correcting a detection temperature of the first temperature sensor by using a predetermined first correction coefficient and calculate a second estimated temperature by correcting a detection temperature of the second temperature sensor by using a predetermined second correction coefficient, and obtain a synthesis temperature of the machine body component by adding the second estimated temperature to the first estimated temperature. The second computing device is configured to calculate the thermal displacement amount of the machine body in the predetermined direction based on the synthesis temperature obtained by the first computing device.

A thermal displacement method for a machine tool is provided. The thermal displacement method includes steps as follows: calculating a first estimated temperature by correcting a detection temperature of a first temperature sensor provided on a surface of each of one or more machine body components forming a machine body by using a predetermined first correction coefficient; calculating a second estimated temperature by correcting a detection temperature of at least one second temperature sensor by using a predetermined second correction coefficient, wherein the at least one second temperature sensor is provided in a non-contact manner with respect to each of the machine body components at a position opposing positions of all of the first temperature sensors and detecting an ambient temperature around the machine body component; calculating a synthesis temperature of the machine body component by adding the second estimated temperature to the first estimated temperature; calculating a thermal displacement amount of the machine body in a predetermined direction based on the calculated synthesis temperature; and performing thermal displacement correction of the machine body in the predetermined direction based on the calculated thermal displacement amount in the predetermined direction.

### BRIEF DESCRIPTION OF THE DRAWINGS

FIG. 1 is a left side view of a wire electrical discharge machine according to an embodiment of the invention.

FIG. 2 is a perspective view of the wire electrical discharge machine shown in FIG. 1.

FIG. 3 is a chart showing an example of test results indicating the relationship between thermal displacement amount of machine body component and synthesis temperature by using a correlation coefficient.

FIG. 4 is a graph showing an example of results of thermal displacement correction by the thermal displacement correction method of the invention.

### DESCRIPTION OF THE EMBODIMENTS

A machine tool according to an embodiment of the invention includes: a first temperature sensor, provided on a surface of each of one or more machine body components selected for forming a machine body; and at least one second temperature sensor, provided in a non-contact manner with respect to each of the machine body components at a position opposing positions of all of the first temperature sensors, and detecting an ambient temperature around the machine body component; and a control device, including a first computing device and a second computing device and performing thermal displacement correction of the machine body in a predetermined direction. The first computing device is configured to calculate, for each of the one or more machine body components, a first estimated temperature by correcting a detection temperature of the first temperature sensor by using a predetermined first correction coefficient and calculate a second estimated temperature by correcting a detection temperature of the second temperature sensor by using a predetermined second correction coefficient, and obtain a synthesis temperature of the machine body component by adding the second estimated temperature to the first estimated temperature. The second computing device is configured to calculate the thermal displacement amount of the machine body in the predetermined direction based on the synthesis temperature obtained by the first computing device.

Preferably, the first temperature sensor is provided at a position as close to a center as possible along the predetermined direction in which the thermal displacement correction is performed on the surface of the machine body component.

In particular, the first correction coefficient and the second correction coefficient are predetermined based on a ratio between the detection temperature of the first temperature sensor and the detection temperature of the second temperature sensor when correlation coefficients between the thermal displacement amounts of the machine body component in the predetermined direction and the synthesis temperatures actually measured multiple times during a predetermined period are obtained and a correlation coefficient is determined to have a strongest correlation relationship among the correlation coefficients.

The correlation coefficient is obtained by an equation as follows:

$$ρ = Cov / σ H \cdot σ T$$

where ρ is the correlation coefficient, Cov is a covariance of the thermal displacement amount in the predetermined direction and the synthesis temperature, σH is a standard deviation of the thermal displacement amount in the predetermined direction, and σT is a standard deviation of the synthesis temperature.

In particular, the one or more machine body components are made of cast iron. In addition, the case where the machine tool is a wire electrical discharge machine is included. In addition, when the machine tool is a wire electrical discharge machine, the predetermined direction is Y-axis direction.

A thermal displacement method for a machine tool is provided. The thermal displacement method includes steps as follows: calculating a first estimated temperature by correcting a detection temperature of a first temperature sensor provided on a surface of each of one or more machine body components forming a machine body by using a predetermined first correction coefficient; calculating a second estimated temperature by correcting a detection temperature of at least one second temperature sensor by using a predetermined second correction coefficient, wherein the at least one second temperature sensor is provided in a non-contact manner with respect to each of the machine body components at a position opposing positions of all of the first temperature sensors and detecting an ambient temperature around the machine body component; calculating a synthesis temperature of the machine body component by adding the second estimated temperature to the first estimated temperature; calculating a thermal displacement amount of the machine body in a predetermined direction based on the calculated synthesis temperature; and performing thermal displacement correction of the machine body in the predetermined direction based on the calculated thermal displacement amount in the predetermined direction.

The first correction coefficient and the second correction coefficient are predetermined based on a ratio between the detection temperature of the first temperature sensor and the detection temperature of the second temperature sensor when correlation coefficients between the thermal displacement amounts of the machine body component in the predetermined direction and the synthesis temperatures actually measured multiple times during a predetermined period are obtained and a correlation coefficient is determined to have a strongest correlation relationship among the correlation coefficients.

The correlation coefficient is obtained by an equation as follows:

$$ρ = Cov / σ H \cdot σ T$$

where ρ is the correlation coefficient, Cov is a covariance of the thermal displacement amount in the predetermined direction and the synthesis temperature, σH is a standard deviation of the thermal displacement amount in the predetermined direction, and σT is a standard deviation of the synthesis temperature.

In particular, the predetermined direction is Y-axis direction. In addition, the predetermined directions to be corrected are Y-axis direction and V-axis direction.

The temperature of the surface of the machine body component can be detected by the first temperature sensor. The ambient temperature around the machine body component can be detected by the second temperature sensor. The internal temperature of the machine body component can be estimated by multiplying the change in temperature of the surface of the machine body component by the predetermined first correction coefficient obtained in advance. Also, the temperature that affects the first temperature sensor can be estimated by multiplying the environmental temperature by the predetermined second correction coefficient obtained in advance. Therefore, the internal temperature of the machine body component can be obtained more accurately by adding the second estimated temperature to the first estimated temperature.

According to the machine tool of the invention, the thermal displacement amount of each machine body component can be calculated based on the more accurate internal temperature of the machine body component. Therefore, even in the case where it is difficult to provide a temperature sensor inside the machine body component, the thermal displacement amount of each machine body component can be calculated based on the internal temperature of the machine body component, and thermal displacement correction can be performed more accurately for the entire machine body. As a result, more effective and higher precision machining can be performed more easily.

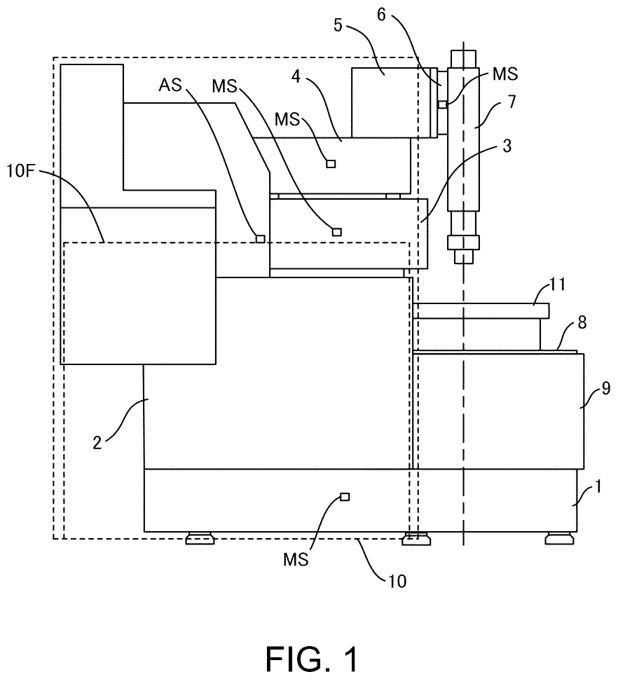

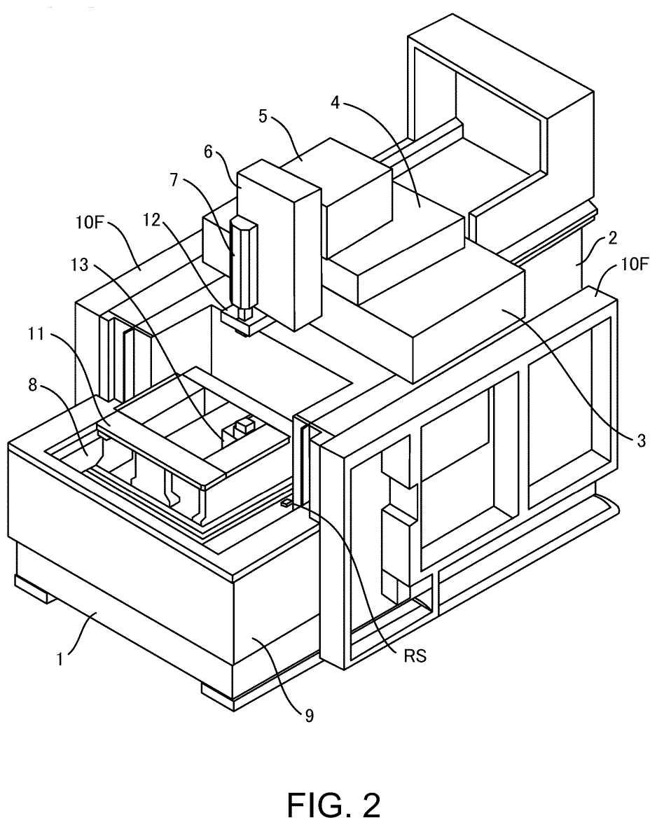

FIG. 1 and FIG. 2 show the general configuration of a machine tool according to a representative embodiment of the invention. The machine tool shown in FIG. 1 and FIG. 2 is a wire electrical discharge machine. FIG. 1 and FIG. 2 show a state where a tank wall of a machining tank of the wire electrical discharge machine descends to a lower limit position. In the wire electrical discharge machine shown in FIG. 1 and FIG. 2, the direction in which the machining tank is installed from the center of the machine body is defined as the front side of the machine body, the right direction when viewed from the front side is defined as the right side of the machine body, the left direction when viewed from the front side is defined as the left side of the machine body, and the direction opposite to the front direction is defined as the rear side. The wire electrode as a tool and the conductive workpiece are both omitted from illustration.

The wire electrical discharge machine of the embodiment shown in FIG. 1 and FIG. 2 includes a bed 1, a column 2, a cross beam 3, a base 4, a top beam 5, a slider 6, a head 7, and a table 8 as main machine body components that significantly affect the thermal displacement in the entire machine body. Additionally, the wire electrical discharge machine of the embodiment includes a machining tank 9 and a cover 10 as main auxiliary machine body components. Furthermore, the wire electrical discharge machine of the embodiment includes a work stand 11, an upper arm 12, and a lower arm 13 as main supplementary machine body components.

In the wire electrical discharge machine of the embodiment, more precisely, with the bed 1 as a base portion, the column 2 is integrally molded with the bed 1 as an upright portion of the bed 1 to form one machine body component, and the column 2 is a portion of the bed 1 and is included in the bed 1. However, since there are machine tools having a structure similar to the wire electrical discharge machine of the embodiment where the base portion and upright portion of the bed 1 are separately molded, the column 2 is shown as divided in the description of the embodiment for the ease of description. However, in the description for the calculation of thermal displacement amounts in the main machine body components, the column 2 may be included in the bed 1 and treated as the bed 1.

The bed 1 is a base. The bed 1 is installed on a floor surface. The column 2 is an upright portion of the bed 1 that is integrally molded with the bed 1. The cross beam 3, the base 4, the top beam 5, and the slider 6 are each a moving body that reciprocates in the horizontal direction. The cross beam 3, the base 4, and the top beam 5 are sequentially stacked and installed on the upper surface of the bed 1 including the column 2. The slider 6 is provided on the front surface of the top beam 5. The head 7 is a moving body that reciprocates in the vertical direction. The head 7 is provided on a surface of the slider 6 facing toward the front side of the machine body. The table 8 is a work table. The table 8 is fixed on the front upper surface of the bed 1.

In the wire electrical discharge machine of the embodiment, the main machine body components of the bed 1 including the column 2, the cross beam 3, the base 4, the top beam 5, the slider 6, the head 7, and the table 8 are all made of cast iron. Even in the case of a machine tool where some or all of the main machine body components are made of materials with small thermal displacement such as carbon fiber reinforced plastics (CFRP) or ceramics, obtaining the thermal displacement amount of the machine body by the thermal displacement correction method of the invention is still beneficial.

The cross beam 3 is a Y-axis moving body that reciprocates in Y-axis direction, which is a horizontal linear single-axis direction. The base 4 is an X-axis moving body that reciprocates in X-axis direction, which is a horizontal linear single-axis direction orthogonal to Y-axis direction. The top beam 5 is a V-axis moving body that is a taper axis and reciprocates in V-axis direction, which is a horizontal linear single-axis direction parallel to Y-axis direction. The slider 6 is a U-axis moving body that is a taper axis and reciprocates in U-axis direction, which is a horizontal linear single-axis direction parallel to X-axis direction. The head 7 is a spindle moving body that reciprocates in Z-axis direction, which is a vertical linear single-axis direction. The table 8 is fixed on the bed 1 and substantially forms a bottom plate of the machining tank 9.

The machining tank 9 is a tank that stores electrical discharge machining liquid when a workpiece is machined by immersing the workpiece in the electrical discharge machining liquid. The machining tank 9 is a splash guard that covers the workpiece so that the electrical discharge machining liquid supplied to the machining gap does not scatter around the machine body when the workpiece is machined by exposing the workpiece to air. The machining tank 9 is attached onto the front upper surface of the bed 1.

The cover 10 is, for example, a protective plate that prevents something from entering or colliding with the lower side of the machine body. The cover 10 is provided on both left and right sides of the machine body at a slight distance from the machine body. FIG. 1 and FIG. 2 show a state where the cover 10 is removed. In particular, in FIG. 1, the position of the cover 10 is indicated by a dotted line. In the wire electrical discharge machine of the embodiment, a panel-type cover that covers the head is provided on the front side of the machine body, but the illustration and description thereof are omitted. Additionally, a cover may be provided on the upper surface side or the rear surface side of the machine body as necessary, but the detailed description thereof is omitted.

The work stand 11 is provided upright on the table 8 so that a workpiece is arranged straddling over the lower arm 13. The work stand 11 is a support base that can fix the workpiece and supply power to the workpiece. The upper arm 12 supports an upper guide assembly including an upper wire guide (not shown). The lower arm 13 supports a lower guide assembly including a lower wire guide (not shown).

The three side walls of the machining tank 9, which are the front wall and both left and right walls, integrally reciprocate in W-axis direction, which is a vertical linear single-axis direction parallel to Z-axis direction. In other words, the machining tank 9 moves up and down in the vertical direction. A workpiece (not shown) is attached to the work stand 11 by an appropriate method. The workpiece is completely accommodated in the machining tank 9 when the machining tank 9 rises to the uppermost position.

First temperature sensors MS that detect the temperatures of the surfaces of the machine body components are provided on one or more selected main machine body components that form the machine body. In particular, the temperature sensors MS are provided at positions as close to the center as possible along a predetermined direction in which thermal displacement correction is performed on the surfaces of the machine body components. Preferably, the temperature sensors MS are installed at positions sufficiently separated from heat-generating members such as motor coils or positions with high possibility of being locally exposed to direct sunlight for a long period.

In the wire electrical discharge machine of the embodiment shown in FIG. 1 and FIG. 2, when the predetermined direction in which thermal displacement correction is performed is Y-axis direction, the first temperature sensors MS are provided on the bed 1, the cross beam 3, the base 4, and the slider 6, respectively. The temperature sensor MS is, for example, a thermistor. Each of the temperature sensors MS provided on the bed 1, the cross beam 3, the base 4, and the slider 6 is attached by an appropriate method so that the detection portion accurately contacts the surface of the machine body component.

At least one second temperature sensor AS is provided at a position opposing the position of each of the first temperature sensors MS of all the machine body components. The at least one second temperature sensor AS detects the ambient temperature around the machine body components or the first temperature sensors MS in a non-contact manner with respect to each of the machine body components. Generally, the ambient temperature around the machine body components is the room temperature at where the wire electrical discharge machine is installed.

The second temperature sensor AS is provided at a position that can better detect the ambient temperature and that opposes all the first temperature sensors MS. For example, in the case where all of the temperature sensors MS are oriented in the same direction and provided on the surfaces of the respective machine body components like the wire electrical discharge machine of the embodiment shown in FIG. 1 and FIG. 2, the temperature sensor AS is provided at a position opposing all the temperature sensors MS at a small distance therebetween.

The second temperature sensor AS is a thermistor same as the first temperature sensor MS. The temperature sensor AS is not in contact with all of the main machine body components. To better detect the ambient temperature, the temperature sensor AS is preferably installed at a position sufficiently separated from heat-generating members such as motor coils, for example. Also, preferably, the temperature sensor AS is arranged to be, as much as possible, not separated from all the temperature sensors MS.

When there is a temperature difference among the first temperature sensors MS to an extent that causes an unacceptable error in the thermal displacement correction amount of the machine body calculated between the actual ambient temperature of the environment at the temperature sensor MS and the ambient temperature of the environment detected by the second temperature sensor AS due to a large separation distance to the second temperature sensor AS, another second temperature sensor AS can be provided at a position that falls within an acceptable temperature difference.

As shown in FIG. 1 and FIG. 2, in the wire electrical discharge machine of the embodiment, the first temperature sensors MS are provided on the side surfaces facing the left direction of the machine body in each of the bed 1, the cross beam 3, the base 4, and the slider 6. Also, one single second temperature sensor AS is provided on a frame 10F between each of the machine body components and the cover 10 at a small distance from the temperature sensors MS. However, in the bed 1 including the column 2, since the temperature of the electrical discharge machining liquid stored in the machining tank 9 provided on the front upper surface of the bed 1 also affects the thermal displacement thereof, it is excluded from the target of thermal displacement correction in the present embodiment.

There is a time delay until the internal temperature of the machine body component becomes the same temperature as the surface temperature of the machine body component. Therefore, there is a temperature difference between the detection temperature of the temperature sensor MS and the internal temperature of the machine body component at the time of temperature detection by the temperature sensor MS. Accordingly, the thermal displacement amount of the machine body component can be accurately obtained by calculating with a predetermined calculation formula based on the internal temperature of the machine body component.

Therefore, by multiplying the detection temperature of the first temperature sensor MS by a first predetermined correction coefficient taking into consideration the time delay, the internal temperature of the machine body component is estimated from the surface temperature of the machine body component at the time when the temperature sensor MS detected the temperature. The estimated internal temperature of the machine body component is defined as a first estimated temperature.

Here, the detection temperature of the first temperature sensor MS is the surface temperature of the machine body component. However, to be more specifically, the temperature includes the influence of the ambient temperature around the machine body component. Therefore, simply, the temperature obtained by subtracting the temperature component that affects the temperature sensor MS from the detection temperature of the second temperature sensor AS that detects the ambient temperature from the detection temperature of the temperature sensor MS can be regarded as the surface temperature of the machine body component.

The detection temperature of the second temperature sensor AS may be slightly affected by the temperature of the member to which the temperature sensor AS is attached. Also, since the temperature sensor AS is provided at a position slightly separated from the first temperature sensor MS, there may be a slight temperature difference between the temperature around the temperature sensor MS and the detection temperature of the temperature sensor AS.

Therefore, by multiplying the detection temperature of the second temperature sensor AS by a predetermined second correction coefficient to comprehensively correspond to the extent to which the ambient temperature of the surrounding affects the detection temperature of the first temperature sensor MS, the temperature component of the ambient temperature that affects the temperature sensor MS is defined as a second estimated temperature.

The detection signal of the first temperature sensor MS and the detection signal of the second temperature sensor AS are input to a control device (not shown). The control device defines, as T, the synthesis temperature of a selected main machine body component that is a thermal displacement correction target in a predetermined direction among multiple main machine body components forming the machine body, as Q_{M}, the detection temperature of the first temperature sensor MS, as Q_{A}, the detection temperature of the second temperature sensor AS, as K_{M}, the first correction coefficient, and, as K_{A}, the second correction coefficient, and obtains the synthesis temperature T of such machine body component according to the following calculation equation. The unit of temperature is Celsius.

$$T [ °C ] = {K}_{M} \cdot {Q}_{M} + {K}_{A} \cdot {Q}_{A} \qquad ( 1 )$$

The first correction coefficient K_{M} and the second correction coefficient K_{A} in Equation 1 can be obtained through experimentation for each machine model. Specifically, the first correction coefficient K_{M} and the second correction coefficient K_{A} are, for all the machine body components that generate thermal displacement affecting errors in positions in the predetermined direction, obtained from the correlation coefficient between the thermal displacement amount in the predetermined direction of each machine body component and the synthesis temperature by, for example, measuring the thermal displacement in the predetermined direction of each machine body component for a predetermined time while measuring the temperature of the surface of each machine body component and the ambient temperature around each machine body component.

The correlation coefficient of the synthesis temperature with respect to the thermal displacement amount of the machine body component in the predetermined direction actually measured at each predetermined time is obtained, and the correction coefficients K_{M} and K_{A} are determined based on the ratio between the detection temperature of the first temperature sensor MS and the detection temperature of the second temperature sensor AS when the correlation coefficient that is determined to have the strongest correlation relationship. At this time, the sum of the correction coefficients K_{M} and K_{A} is set to 1. The correlation coefficient ρ can be obtained by the following equation. In the following equation, Cov is the covariance of the thermal displacement amount in the predetermined direction and the synthesis temperature, σH is the standard deviation of the thermal displacement amount in the predetermined direction, and σT is the standard deviation of the synthesis temperature.

$$ρ = Cov / σ H \cdot σ T \qquad ( 2 )$$

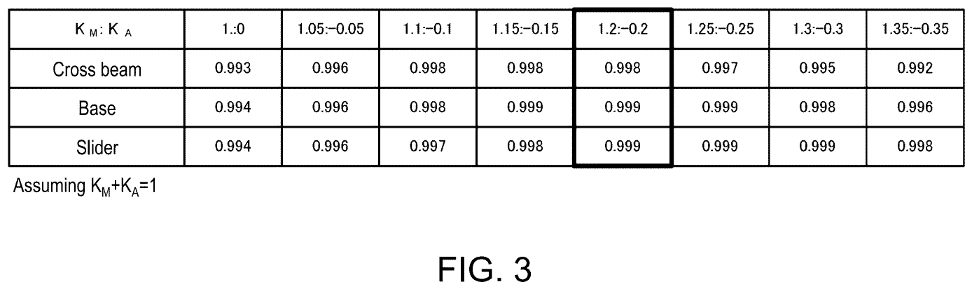

FIG. 3 shows the values of the correlation coefficients between thermal displacement amount in Y-axis direction and synthesis temperature for the cross beam 3, the base 4, and the slider 6, which are selected main machine body components arranged in the vertical direction and affect the errors of positions in Y-axis direction as the predetermined direction in the wire electrical discharge machine of the embodiment. For example, according to FIG. 3, it is found that for all machine body components, it is appropriate to set the correction coefficient K_{M} to 1.2 and the correction coefficient K_{A} to −0.2 based on the ratio between the machine body surface temperature and the ambient temperature when the correlation coefficient is at a value closest to 1.000 and the correlation relationship between the thermal displacement amount and the synthesis temperature is determined to be the strongest.

In the embodiment shown in FIG. 3, the correlation coefficients for the machine body components of the cross beam 3, the base 4, and the slider 6 are obtained simultaneously with the first correction coefficient K_{M} from the synthesis temperature of the machine body. Therefore, the first correction coefficient K_{M} and the second correction coefficient K_{A} become the same values at the time of obtaining the thermal displacement amount of each machine body component in calculating the synthesis temperature for each machine body component, but no computational problems arise. Additionally, the method for obtaining the correction coefficient is not limited to using the correlation coefficient.

The thermal displacement amount of each machine body component can be obtained from the following conventional equation. Where H is the thermal displacement amount (μm) of the machine body component in the predetermined direction, Tₙ is the synthesis temperature at a certain time (n is an integer), α is the linear expansion coefficient of the machine body component (/° C.·m), and L is the length of the machine body component (m).

$$H = ( {T}_{n} - {T}_{n + 1} ) α \cdot L \qquad ( 3 )$$

The thermal displacement amount of the machine body in the predetermined direction is the sum of the thermal displacement amounts of multiple machine body components arranged in the predetermined direction. For example, in the wire electrical discharge machine of the embodiment, the thermal displacement amount in Y-axis direction as the horizontal linear single-axis direction becomes a value obtained by adding the thermal displacement amounts of the cross beam 3, the base 4, and the slider 6 in Y-axis direction. At this time, instead of obtaining the thermal displacement amount of the machine body in the predetermined direction from the sum of the thermal displacement amounts of multiple machine body components, for example, a conventional method for obtaining the thermal displacement amount of the machine body in the predetermined direction from the synthesis temperature of multiple machine body components can be utilized.

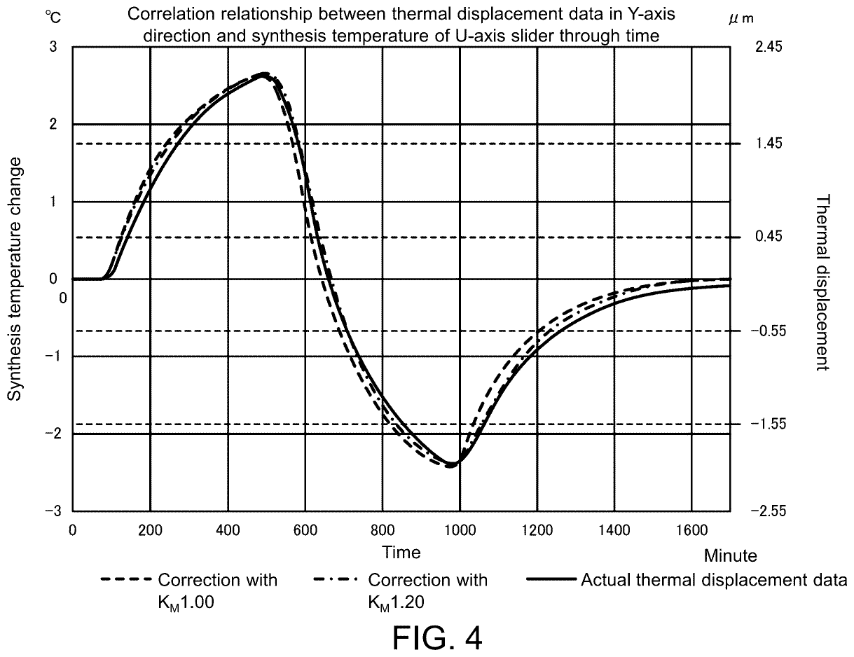

FIG. 4 shows a result of comparison between calculating a thermal displacement amount H by determining the correction coefficient K_{M} and the correction coefficient K_{A} in Equation 2 from the correlation coefficients shown in FIG. 3 and obtaining the synthesis temperature T in Y-axis direction for each of multiple machine body components, and actually measuring the thermal displacement amount in the wire electrical discharge machine of the embodiment of FIG. 1 and FIG. 2.

The control device (not shown) includes a first computing device that obtains the synthesis temperatures T of multiple machine body components, and a second computing device that calculates the thermal displacement amount H of the machine body in the predetermined direction based on the synthesis temperatures T obtained by the first computing device, and is a device that performs thermal displacement correction of the machine body in the predetermined direction based on the thermal displacement amount H calculated by the second computing device.

The first computing device calculates, for each machine body component, the first estimated temperature obtained by correcting the detection temperature of the first temperature sensor MS by using the predetermined first correction coefficient K_{M}, calculates the second estimated temperature by correcting the detection temperature of the second temperature sensor AS by using the predetermined second correction coefficient K_{A}, and adds the second estimated temperature to the first estimated temperature to obtain the synthesis temperature of the machine body component. The second computing device calculates the thermal displacement amount H of the machine body in the predetermined direction based on the synthesis temperature T obtained by the first computing device. The first computing device and the second computing device can be configured as one computing device.

The control device inputs the detection temperatures from the first temperature sensor MS and the second temperature sensor AS at a predetermined time to obtain the thermal displacement amount of each machine body component in the predetermined direction. Then, the control device corrects the error of the position due to the thermal displacement amount of the entire machine body in the predetermined direction from the sum of the thermal displacement amounts of the respective machine body components in the predetermined direction.

In the wire electrical discharge machine of the embodiment, the error of the machining position due to the thermal displacement amount generated in the horizontal linear single-axis direction passing through the front and rear of the machine body appears dispersed as a Y-axis direction position error determined by the position of the lower wire guide on a predetermined machined surface, and a V-axis direction position error determined by the position of the upper wire guide on a taper surface. Therefore, the control device performs, for example, correction of the Y-axis direction position error based on the thermal displacement amount of the cross beam 3, and performs correction of the V-axis direction position error based on the thermal displacement amounts of the base 4 and slider 6.

Next, an embodiment of a thermal displacement correction method in the machine tool of the invention will be described. The embodiment described below is a thermal displacement correction method suitable for the wire electrical discharge machine shown in FIG. 1 and FIG. 2.

In the wire electrical discharge machine shown in FIG. 1 and FIG. 2, the first temperature sensors MS are provided on the side surfaces of the cross beam 3, the base 4, and the slider 6, respectively, corresponding to the left side of the machine body. The second temperature sensor AS is provided on supplementary equipment such as the frame 10F located between the cover 10 provided on the left side of the machine body and the main machine body components.

The predetermined direction for performing thermal displacement correction is Y-axis direction. The first correction coefficient K_{M} and the second correction coefficient K_{A} are obtained in advance. As already described, the first correction coefficient K_{M} and the second correction coefficient K_{A} are determined based on the ratio between the detection temperature Q_{M} of the first temperature sensor MS and the detection temperature Q_{A} of the second temperature sensor AS when a correlation coefficient is determined to have the strongest correlation relationship among multiple correlation coefficients obtained by determining the correlation coefficients between the thermal displacement amounts in Y-axis direction and the synthesis temperatures of the cross beam 3, the base 4, and the slider 6, which are the machine body components, actually measured multiple times during a predetermined period.

In the following description, the first estimated temperature is the internal temperature of the machine body component estimated by multiplying the detection temperature Q_{M} of the first temperature sensor MS by the first predetermined correction coefficient K_{M} that takes into consideration of a time delay. Also, the second estimated temperature is a temperature component of the ambient temperature that affects the temperature sensor MS, estimated by multiplying the detection temperature Q_{A} of the second temperature sensor AS by the predetermined second correction coefficient K_{A}.

First, the first estimated temperature is calculated by correcting the detection temperature Q_{M} of the first temperature sensor MS provided on the surface of each of the cross beam 3, the base 4, and the slider 6, which are the selected machine body components closely related to the thermal displacement correction in Y-axis direction in the wire electrical discharge machine of the embodiment, by using the predetermined first correction coefficient K_{M}. This is the step of calculating the first estimated temperature in the embodiment. Also, the second estimated temperature is calculated by correcting the detection temperature Q_{A} of the second temperature sensor AS with a predetermined second correction coefficient K_{A}. This is the step of calculating the second estimated temperature in the embodiment. Then, the second estimated temperature is added to the first estimated temperature to obtain the synthesis temperature T of each machine body component of the cross beam 3, the base 4, and the slider 6, respectively. This is the step of obtaining the synthesis temperature T in the embodiment.

Next, the thermal displacement amount H of the machine body in Y-axis direction is calculated based on the synthesis temperature T. This is the step of calculating the thermal displacement amount H in the embodiment. When the thermal displacement amounts of the cross beam 3, the base 4, and the slider 6 are calculated respectively, the sum of the thermal displacement amounts of the respective machine body components is taken as the thermal displacement amount of the machine body. Then, the thermal displacement correction of the machine body in Y-axis direction is performed based on the calculated thermal displacement amount Hin Y-axis direction. This is the step of performing thermal displacement correction in the embodiment.

In the wire electrical discharge machine of the embodiment, the error of the machining position due to the thermal displacement amount generated in the horizontal linear single-axis direction passing through the front and rear of the machine body appears dispersed as a Y-axis direction position error determined by the position of the lower wire guide on a predetermined machined surface, and a V-axis direction position error determined by the position of the upper wire guide on a taper surface. Therefore, correction of the position error in Y-axis direction is performed based on the thermal displacement amount of the cross beam 3, and correction of the position error in V-axis direction is performed based on the thermal displacement amounts of the base 4 and the slider 6.

When the position error in X-axis direction, which is another horizontal linear single-axis direction orthogonal to Y-axis direction as the predetermined direction, is corrected or when the position error in Z-axis direction, which is a vertical linear single-axis direction orthogonal to Y-axis direction, is corrected, the thermal displacement correction can also be performed in the same manner as the method for correcting the position error in Y-axis direction. As in the wire electrical discharge machine of the embodiment, due to the structure of the machine body in which the lower arm 13 extending in Y-axis direction supports the wire guide, the influence of thermal displacement on the required positioning accuracy is relatively small in X-axis direction and Z-axis direction, so it is not necessary to perform thermal displacement correction by the thermal displacement correction method of the invention.

A third temperature sensor RS provided in the machining tank 9 is used to constantly detect the liquid temperature of the electrical discharge machining liquid to maintain the liquid temperature of the electrical discharge machine in the machining tank 9 to be constant. The third temperature sensor RS can be utilized as a temperature sensor that detects the ambient temperature of the environment at the time of performing thermal displacement correction of the bed 1 in the wire electrical discharge machine of the embodiment. Also, for example, it can be utilized to estimate the temperature of the lower arm 13.

At the time of performing correction of the bed 1 by utilizing the third temperature sensor RS through the thermal displacement correction method of the invention, for example, the ambient temperature around the bed 1 can be determined by the synthesis temperature of the first temperature sensor MS provided on the surface of the bed 1 and the third temperature sensor RS.

The machine tool and the thermal displacement correction method for the machine tool of the invention described above are not limited to the wire electrical discharge machine and the thermal displacement correction method of the embodiment, and although several examples have already been shown, the embodiments can be implemented with substitution, modification, or combination within the scope that does not depart from the technical concept of the invention.

For example, instead of the wire electrical discharge machine having a structure in which the cross beam that reciprocates in Y-axis direction is mounted on the upper surface of a column that is integrally molded with the bed and is portion of the bed as shown in the embodiment, and a base that moves in X-axis direction is mounted on the cross beam, the invention can be applied to a cutting machine having a structure in which a saddle that reciprocates in Y-axis direction is mounted on the bed and a table that reciprocates in X-axis direction is mounted on the saddle.

What is claimed is:

1. A machine tool, comprising:
a first temperature sensor, provided on a surface of each of one or more machine body components selected for forming a machine body; and
at least one second temperature sensor, provided in a non-contact manner with respect to each of the machine body components at a position opposing positions of all of the first temperature sensors, and detecting an ambient temperature around the machine body component; and
a control device, comprising a first computing device and a second computing device and performing thermal displacement correction of the machine body in a predetermined direction, wherein the first computing device is configured to calculate, for each of the one or more machine body components, a first estimated temperature by correcting a detection temperature of the first temperature sensor by using a predetermined first correction coefficient and calculate a second estimated temperature by correcting a detection temperature of the second temperature sensor by using a predetermined second correction coefficient, and obtain a synthesis temperature of the machine body component by adding the second estimated temperature to the first estimated temperature, and the second computing device is configured to calculate the thermal displacement amount of the machine body in the predetermined direction based on the synthesis temperature obtained by the first computing device.

2. The machine tool as claimed in claim 1, wherein the first temperature sensor is provided at a position as close to a center as possible along the predetermined direction in which the thermal displacement correction is performed on the surface of the machine body component.

3. The machine tool as claimed in claim 1, wherein the first correction coefficient and the second correction coefficient are predetermined based on a ratio between the detection temperature of the first temperature sensor and the detection temperature of the second temperature sensor when correlation coefficients between the thermal displacement amounts of the machine body component in the predetermined direction and the synthesis temperatures actually measured multiple times during a predetermined period are obtained and a correlation coefficient is determined to have a strongest correlation relationship among the correlation coefficients.

4. The machine tool as claimed in claim 3, wherein the correlation coefficient is obtained by an equation as follows:
$$ρ = Cov / σ H \cdot σ T$$
wherein ρ is the correlation coefficient, Cov is a covariance of the thermal displacement amount in the predetermined direction and the synthesis temperature, σH is a standard deviation of the thermal displacement amount in the predetermined direction, and σT is a standard deviation of the synthesis temperature.

5. The machine tool as claimed in claim 1, wherein the one or more machine body components are made of cast iron.

6. The machine tool as claimed in claim 1, wherein the machine tool is a wire electrical discharge machine.

7. The machine tool as claimed in claim 6, wherein the predetermined direction is Y-axis direction.

8. A thermal displacement method for a machine tool, the thermal displacement method comprising steps as follows:
calculating a first estimated temperature by correcting a detection temperature of a first temperature sensor provided on a surface of each of one or more machine body components forming a machine body by using a predetermined first correction coefficient;
calculating a second estimated temperature by correcting a detection temperature of at least one second temperature sensor by using a predetermined second correction coefficient, wherein the at least one second temperature sensor is provided in a non-contact manner with respect to each of the machine body components at a position opposing positions of all of the first temperature sensors and detecting an ambient temperature around the machine body component;
calculating a synthesis temperature of the machine body component by adding the second estimated temperature to the first estimated temperature;
calculating a thermal displacement amount of the machine body in a predetermined direction based on the calculated synthesis temperature; and
performing thermal displacement correction of the machine body in the predetermined direction based on the calculated thermal displacement amount in the predetermined direction.

9. The thermal displacement correction method for the machine tool as claimed in claim 8, wherein the first correction coefficient and the second correction coefficient are predetermined based on a ratio between the detection temperature of the first temperature sensor and the detection temperature of the second temperature sensor when correlation coefficients between the thermal displacement amounts of the machine body component in the predetermined direction and the synthesis temperatures actually measured multiple times during a predetermined period are obtained and a correlation coefficient is determined to have a strongest correlation relationship among the correlation coefficients.

10. The thermal displacement correction method for the machine tool as claimed in claim 9, wherein the correlation coefficient is obtained by an equation as follows:
$$ρ = Cov / σ H \cdot σ T$$
wherein ρ is the correlation coefficient, Cov is a covariance of the thermal displacement amount in the predetermined direction and the synthesis temperature, σH is a standard deviation of the thermal displacement amount in the predetermined direction, and σT is a standard deviation of the synthesis temperature.

11. The thermal displacement correction method for the machine tool as claimed in claim 10, wherein the predetermined direction is Y-axis direction.

12. The thermal displacement correction method for the machine tool as claimed in claim 11, wherein the predetermined directions to be corrected are Y-axis direction and V-axis direction.
